(19) United States
(12) Patent Application Publication
(10) Pub. No.: US 2024/0372206 A1
(43) Pub. Date: Nov. 7, 2024

(54) PRESSURE EQUALIZATION DEVICE FOR A BATTERY BOX

(71) Applicant: Illinois Tool Works Inc., Glenview, IL (US)

(72) Inventors: Ilaria GIACOMELLI, Hone (IT); Fulvio Pacifico YON, Donnas (IT); Andrea Giovanni COCCOZ, Ivrea (IT); Eric LEVERGER, Epone (FR)

(21) Appl. No.: 18/642,204

(22) Filed: Apr. 22, 2024

(30) Foreign Application Priority Data
May 5, 2023 (EP) 23171859.4
Mar. 26, 2024 (FR) 2403043

(51) Int. Cl. H01M 50/317; H01M 10/42; H01M 50/30

(52) U.S. Cl. CPC H01M 50/317; H01M 10/4285; H01M 50/394

(57) ABSTRACT

The disclosure relates to a pressure equalization device for a battery box. The device comprises a cage defining a fluid passage, a lid mounted on the cage and a membrane covering the fluid passage to equalize the pressure inside the battery box with the ambient pressure outside the battery box. The lid is movable between a test configuration, in which air can escape through a bypass channel, and an operational configuration, in which the bypass channel is closed but air can escape through the membrane.

### TECHNICAL FIELD

This disclosure relates to the field of pressure equalization devices for compensating pressure variation inside a battery.

### BACKGROUND

WO2023218242 provides a known pressure equalization device for a housing, the device comprising a cage describing a fluid passage, a lid mounted on the cage and a membrane covering the fluid passage to equalize the pressure inside the housing with the ambient pressure outside the housing. The lid is movable between an open configuration in which air can escape, and a closed configuration in which the housing is sealed. This makes it possible to carry out an airtightness test of the entire battery box.

### BRIEF SUMMARY

The present disclosure aims to provide an equalization device that makes it easier to carry out an airtightness test.

Aspects of this disclosure relate to a pressure equalization device for a housing, for example a battery box.

The equalization device can comprise a test configuration and/or an operational configuration.

In the test configuration, the device can be arranged so that air can escape through a bypass channel.

In the operational configuration, the bypass channel can be closed and/or the device can be arranged so that air can escape through the membrane.

Aspects of this disclosure also relate to a pressure equalization device for a housing, for example a battery box, the device comprising a test configuration, in which air can escape through a bypass channel, and an operational configuration, in which the bypass channel is closed but air can escape through the membrane.

The device therefore makes it possible to carry out airtightness tests using a tool that covers the device and introduces pressurized air into the housing via the bypass channel when the device is in the test configuration.

The device can comprise a cage, which can describe a fluid passage.

The device can comprise a lid, which can be mounted on the cage.

The device can comprise a membrane, which can cover the fluid passage, for example to equalize the pressure inside the housing with the ambient pressure outside the housing.

The lid can be movable, when in use, between a test configuration and an operational configuration. The test configuration and/or the operational configuration can correspond to those of the device.

Aspects of this disclosure also relate to a pressure equalization device for a battery box, comprising: a cage describing a fluid passage; a lid mounted on the cage; and a membrane covering the fluid passage to equalize the pressure inside the housing with the ambient pressure outside the housing; in which the lid is movable, when in use, between a test configuration, in which air can escape through a bypass channel, and an operational configuration, in which the bypass channel is closed but air can escape through the membrane.

The membrane can be gas-permeable and/or liquid-impermeable, for example to allow air to pass through it in order to equalize the pressure inside the battery box with the ambient pressure outside the battery box.

More specifically, the membrane can be gas-permeable and liquid-impermeable to allow air to pass through it in order to equalize the pressure inside the battery box with the ambient pressure outside the battery box.

The device can comprise a valve element. The valve element can be configured to deform, for example at a predetermined pressure difference between the inside and the outside of the battery box. The valve element can be configured to deform to prevent overpressure inside the battery box, for example when the lid is in the operational configuration.

More specifically, the device can comprise a valve element configured to deform at a predetermined pressure difference between the inside and the outside of the battery box to prevent overpressure inside the battery box when the lid is in the operational configuration.

The valve element can comprise a hole. The hole can be through its thickness.

More specifically, the valve element can comprise a hole through its thickness.

The lid can be sealed against the hole, for example when the lid is in the operational configuration.

The lid can be spaced apart from the hole, for example when the lid is in the test configuration. The lid can be spaced apart from the hole so that the bypass channel is defined at least in part between the lid and the valve element.

More specifically, the lid can be sealed against the hole when the lid is in the operational configuration and spaced apart from the hole when the lid is in the test configuration, so that the bypass channel is defined at least in part between the lid and the valve element.

The membrane can cover the hole, for example when the lid is in the operational configuration. The membrane can cover the hole so that the hole provides the fluid passage.

More specifically, the membrane can cover the hole when the lid is in the operational configuration so that the hole provides the fluid passage.

The membrane can be attached to the cage. The membrane can cover a hole through the cage.

More specifically, the membrane can be attached to the cage and covers a hole through the cage.

The membrane can be attached to the valve element. The membrane can cover another hole. The other hole can be through the thickness of the valve element.

More specifically, the membrane can be attached to the valve element and covers another hole through the thickness of the valve element.

The membrane can be attached to the valve element. The membrane can cover a hole or another hole. The other hole can be through the thickness of the valve element. The bypass channel can be defined between the lid and the cage.

More specifically, the membrane can be attached to the valve element and covers a hole through the thickness of the valve element and the bypass channel is defined between the lid and the cage.

The valve element can comprise a canopy. The canopy can cover the fluid passage or a second fluid passage defined by the cage.

More specifically, the valve element can comprise a canopy that covers the fluid passage or a second fluid passage defined by the cage.

The cage can comprise a valve seat. The canopy can engage against the valve seat, for example in an airtight manner, when the canopy covers the fluid passage or the second fluid passage.

More specifically, the cage can comprise a valve seat against which the canopy engages in an airtight manner when the canopy covers the fluid passage or the second fluid passage.

The lid can be rotatable, for example between the test configuration and the operational configuration.

More specifically, the lid can be rotatable between the test configuration and the operational configuration.

In some examples, one of the lid and of the cage comprises an inclined, helical or screw-shaped formation. The formation can cooperate with a formation on the other of the lid and of the cage, for example to cause the lid to translate relative to the cage when it is rotated between the test configuration and the operational configuration.

More specifically, one of the lid and of the cage can comprise an inclined, helical or screw-shaped formation that cooperates with a formation on the other of the lid and of the cage to cause the lid to translate relative to the cage when it is rotated between the test configuration and the operational configuration.

Aspects of this disclosure also relate to a test assembly for testing the airtightness of a housing, for example a battery box.

The assembly can comprise a pressure equalization device for a housing, for example a device as described above.

The assembly can comprise a tool. The tool can be configured to cover the device. The tool can be configured to introduce pressurized air into or draw air from the housing, for example when the device is in the test configuration.

Aspects of this disclosure also relate to a test assembly for testing the airtightness of a battery box, the assembly comprising a device according to any preceding claim and a tool configured to cover the device and to introduce pressurized air into or draw air from the battery box when the device is in the test configuration.

For the avoidance of doubt, all the features described herein also apply to any aspect of the disclosure.

For the avoidance of doubt, the terms “can”, “and/or”, “for example”, and any other similar term used herein must be interpreted as not limiting, such that any feature described herein is not necessarily required to be present.

### BRIEF DESCRIPTION OF THE DRAWINGS

Other features and advantages of the disclosure will become apparent from the following detailed description, which will be understood in reference to the appended drawings, in which:

FIG. 1 illustrates a perspective view of a test assembly according to a first example;

FIG. 2 illustrates the test assembly in FIG. 1 with part of the pressure equalization device cross-sectioned to illustrate the internal components of the device when it is in a test configuration;

FIG. 3 illustrates a perspective view of the pressure equalization device in FIGS. 1 and 2 in an unlocked test configuration;

FIG. 4 illustrates the pressure equalization device in FIG. 3 without the lid;

FIG. 5 illustrates a perspective view of the pressure equalization device in FIGS. 1 to 4 in an unlocked operational configuration;

FIG. 6 illustrates a perspective view of the pressure equalization device in FIGS. 1 to 5 in a locked operational configuration;

FIG. 7 illustrates the pressure equalization device in FIG. 6 without the lid;

FIG. 8 illustrates a cross-sectional view of the pressure equalization device in FIGS. 1 to 7 showing the internal components of the device when it is in operational configuration;

FIG. 9 illustrates a schematic view of a test assembly according to a second example with the pressure equalization device in a test configuration;

FIG. 10 illustrates a schematic view of the pressure equalization device in FIG. 9 in an operational configuration under normal operating conditions;

FIG. 11 illustrates a schematic view of the pressure equalization device in FIGS. 9 and 10 in an operational configuration under overpressure conditions;

FIG. 12 illustrates a schematic view of a test assembly according to a third example with the pressure equalization device in a test configuration;

FIG. 13 illustrates a schematic view of the pressure equalization device in FIG. 12 in an operational configuration under normal operating conditions;

FIG. 14 illustrates a schematic view of a test assembly according to a fourth example with the pressure equalization device in a test configuration;

FIG. 15 illustrates a schematic view of the pressure equalization device in FIG. 14 in an operational configuration under normal operating conditions;

FIG. 16 illustrates a schematic view of a test assembly according to a fifth example with the pressure equalization device in a test configuration; and

FIG. 17 illustrates a schematic view of the pressure equalization device in FIG. 16 in an operational configuration under normal operating conditions.

### DETAILED DESCRIPTION

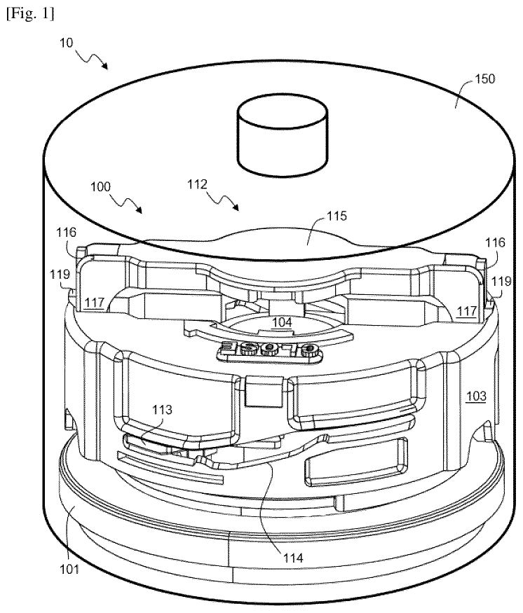

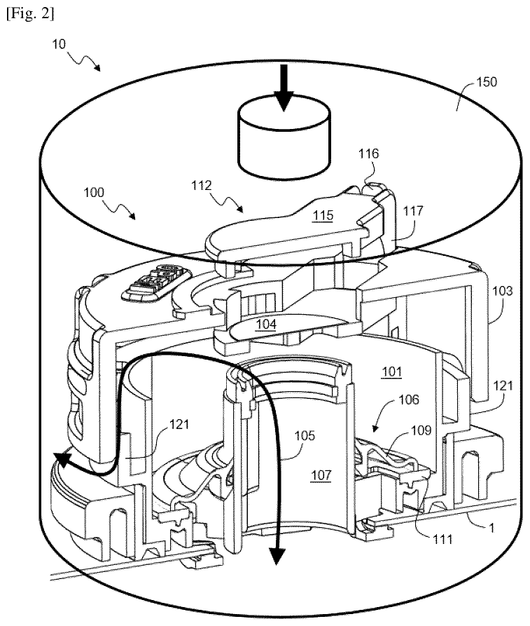

Referring now to FIGS. 1 and 2, a test assembly 10 for testing the airtightness of a battery box 1 can be seen, comprising a pressure equalization device 100 and a tool 150. The device 100 is shown in a test configuration.

As illustrated in FIG. 2, the tool 150 is configured to cover the device 100 and to introduce pressurized air into or draw air from the battery box 1 via a bypass channel 105 of the device 100 when the device 100 is in the test configuration.

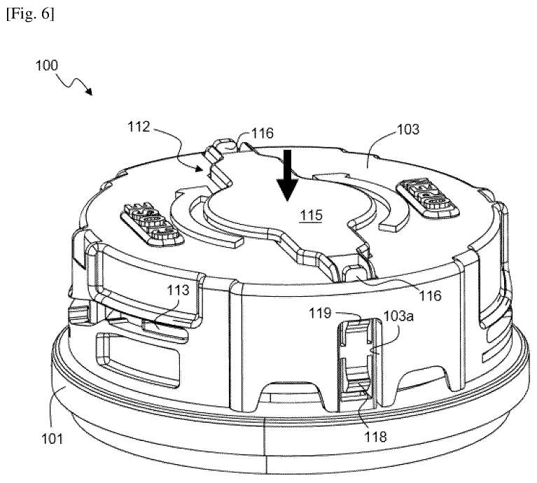

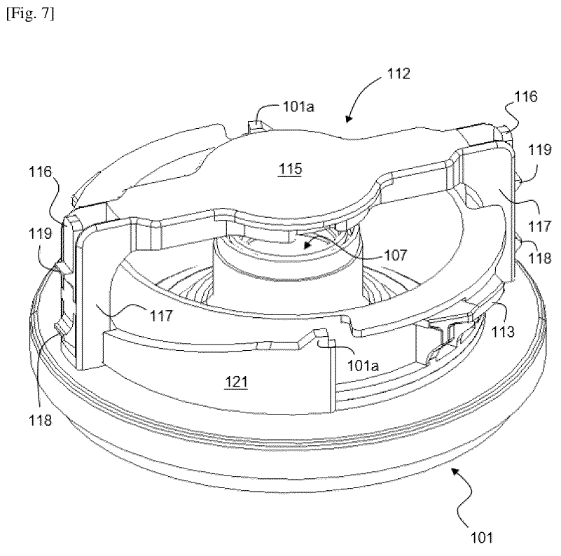

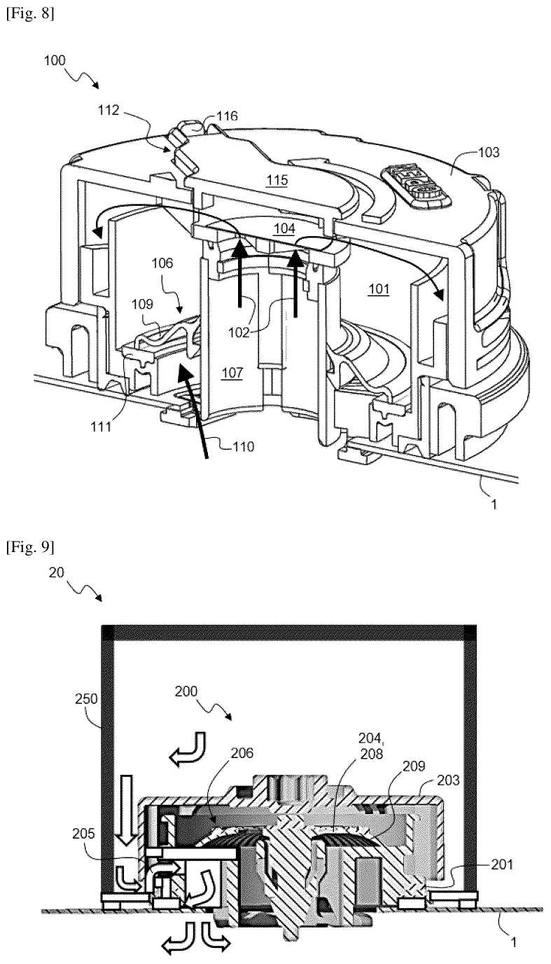

The device 100 comprises a cage 101 describing a fluid passage 102 (see FIG. 8), a lid 103 mounted on the cage 101 and a membrane 104 to cover the fluid passage 102. More specifically, the lid 103 comprises an operational configuration (illustrated in FIGS. 6 to 8), in which the membrane 104 covers the fluid passage 102 and air can escape through the membrane 104 to equalize the pressure inside the battery box 1 with the ambient pressure outside the battery box 1.

Advantageously, the lid 103 is movable, in this rotatable example, between the operational configuration (see FIG. 1) and a test configuration (see FIG. 2). More specifically, the cage 101 and the lid 103 each comprise a pair of screw formations 113, 114 that cooperate to cause the lid 103 to translate relative to the cage 101 when it is rotated between the test configuration and the operational configuration.

In the test configuration (see FIGS. 1 and 2), the air can escape through the bypass channel 105 to allow pressurized air to be introduced into or drawn from the battery box 1.

However, in the operational configuration (see FIGS. 6 and 8), the bypass channel 105 is closed, but air can escape through the membrane 104. The membrane 104 is gas-permeable and liquid-impermeable to allow air to pass through it to equalize the pressure inside the battery box 1 with the ambient pressure outside the battery box 1.

The device 100 comprises a valve element 106 that comprises a central hole 107 through its thickness. The lid 103 is sealed against the hole 107 when it is in the operational configuration. The membrane 104 covers the hole 107 when the lid 103 is in the operational configuration so that the hole 107 provides the fluid passage 102.

The lid 103 is spaced apart from the hole 107 when it is in the test configuration, so that the bypass channel 105 is defined in part between the lid 103 and the valve element 106. The valve element 106 comprises a canopy 109 that covers a second fluid passage 110 defined by the cage 101.

The cage 101 comprises a valve seat 111 against which the canopy 109 engages in an airtight manner when the canopy 109 covers the second fluid passage 110. The canopy 109 is configured to deform at a predetermined pressure difference between the inside and the outside of the battery box 1 to prevent overpressure inside the battery box 1 when the lid 103 is in the operational configuration.

The device 100 also comprises a locking means 112 for keeping the lid 103 in the test configuration and in the operational configuration. In this example, the locking means 112 is in the form of a U-shaped locking member 115 that comprises a spring clip 116 on each of its arms 117. Each clip 116 is parallel to the arm 117, is connected to the free end of the arm 117 by an active hinge and comprises a pair of barbs 118, 119 that are spaced apart and outwardly protruding.

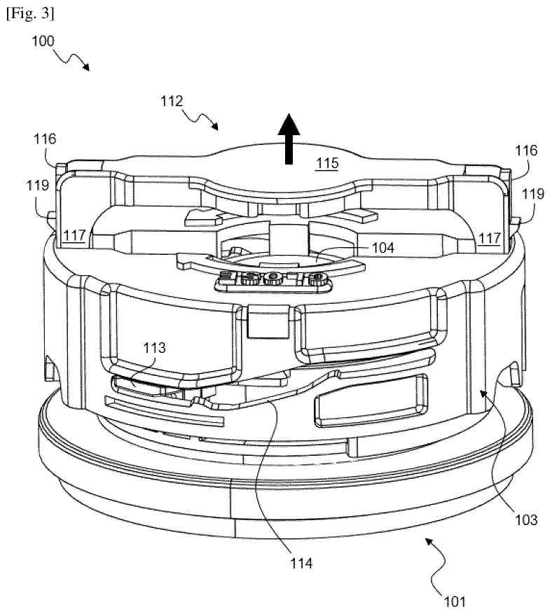

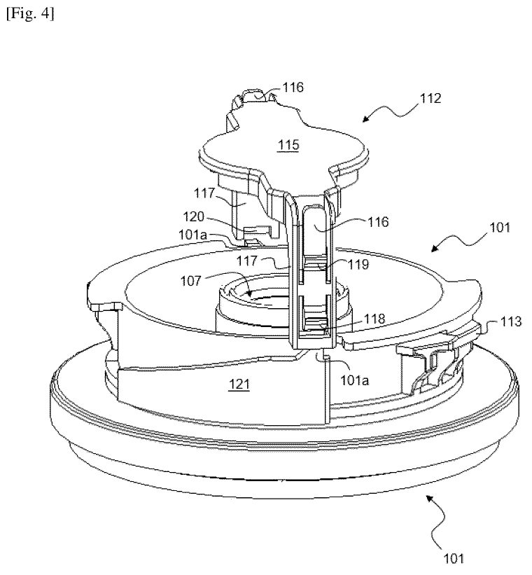

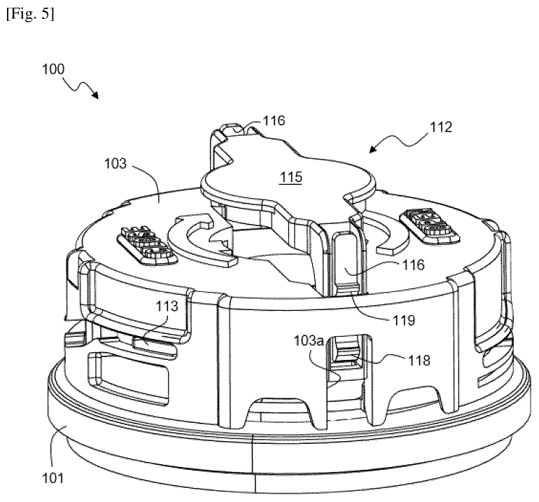

When the lid 103 is locked in the test condition, the locking member 115 is actuated upwards to unlock the lid 103, as illustrated in FIG. 3. As shown more clearly in FIG. 4, this upward movement retracts the locking protuberances 101a on the cage 101 from correspondingly-shaped receptacles 120 in the arms 117 of the locking member 115. This allows the lid 103 to be rotated from the test condition to the operating condition, as illustrated in FIG. 5.

When the lid 103 is in the operational condition, the locking member 115 is pushed down to a locked position. This is illustrated in FIGS. 5 to 8, in which the barbs 119 closest to the free end of the clips 116 snap into the recesses 103a in the lid 103 to prevent inadvertent unlocking. In this locked position, the arms 117 cooperate with one end of a formation 121 of the cage 101 to keep the lid 103 from rotating relative to the cage 101.

To release the locking member 115 from the locked position, a user must press on the clips 116 to release the barbs 119 from the recess 103a of the lid 103 and retract the locking member 115 upwards. The lid 103 can then be rotated to return to the test condition.

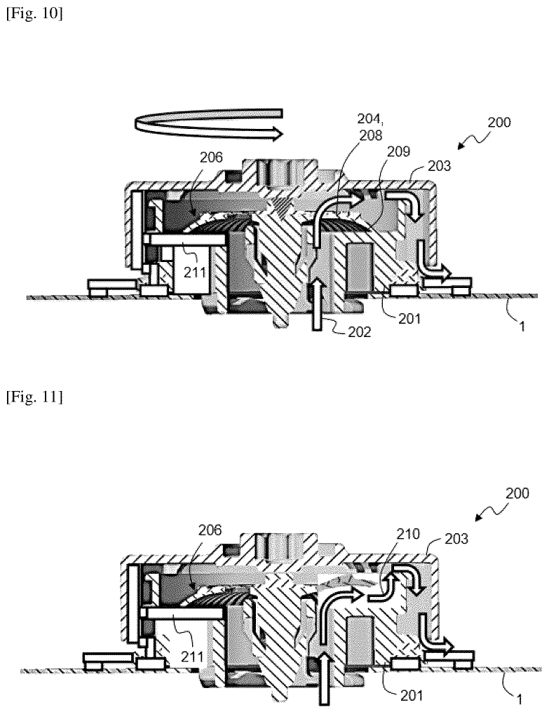

FIGS. 9 to 11 show a pressure equalization device 200 according to another example similar to the pressure equalization device 100 in FIGS. 1 to 8, where similar references represent similar features, incremented by 100. The device 200 is part of a test assembly 20 for testing the airtightness of a battery box 1, similar to the test assembly 10 described above, which comprises a tool 250.

The device 200 according to this example differs from that of FIGS. 1 to 8 in that the membrane 204 is attached to the valve element 206 and covers a hole 208 through the thickness of the valve element 206; the bypass channel 205 is defined between the lid 203 and the cage 201 and not through the valve element 206. The locking means 112 is also omitted.

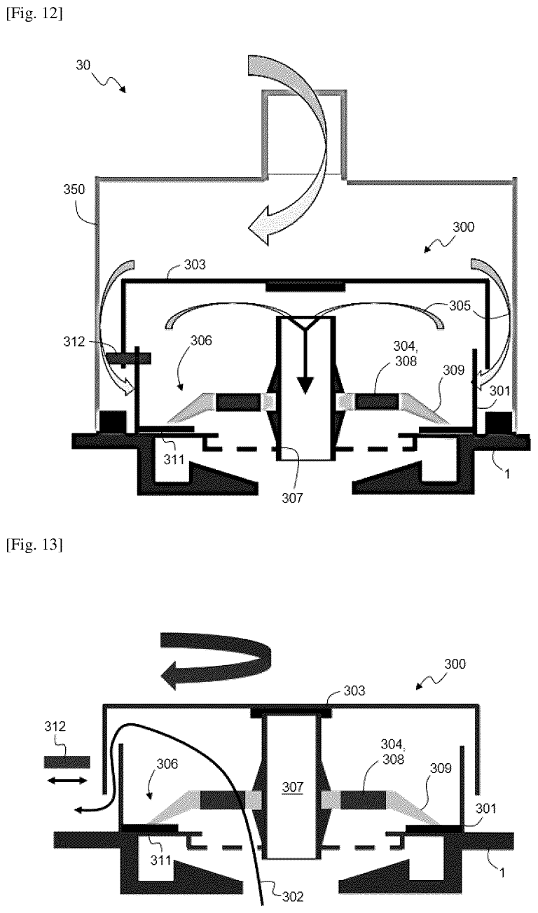

FIGS. 12 and 13 show a pressure equalization device 300 according to another example similar to the pressure equalization device 100 in FIGS. 1 to 8, where similar references represent similar features, incremented by 200. The device 300 is part of a test assembly 30 for testing the airtightness of a battery box 1, similar to the test assembly 10 described above, which comprises a tool 350.

The device 300 according to this example differs from that of FIGS. 1 to 8 in that the membrane 304 is attached to the valve element 306 and covers a hole 308 through the thickness of the valve element 306 and the locking means 312 is radially inserted between the locked and unlocked positions. In this example, the central hole 307 passing through the valve element 306 is hermetically sealed by the lid 303 when the lid 303 is in the operational condition.

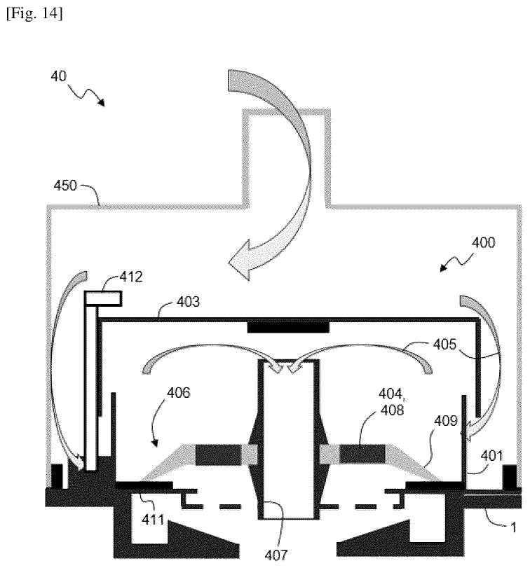

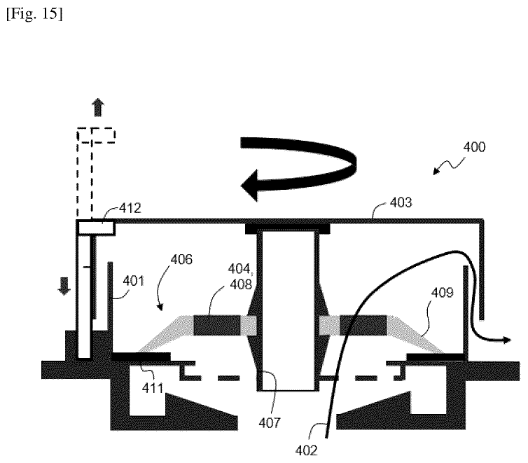

FIGS. 14 and 15 show a pressure equalization device 400 according to another example similar to the pressure equalization device 300 in FIGS. 12 and 13, where similar references represent similar features, incremented by 100. The device 400 is part of a test assembly 40 for testing the airtightness of a battery box 1, similar to the test assembly 30 described above, which comprises a tool 450.

The device 400 according to this example differs from that in FIGS. 12 and 13 in that the locking means 412 is axially inserted between the locked and unlocked positions.

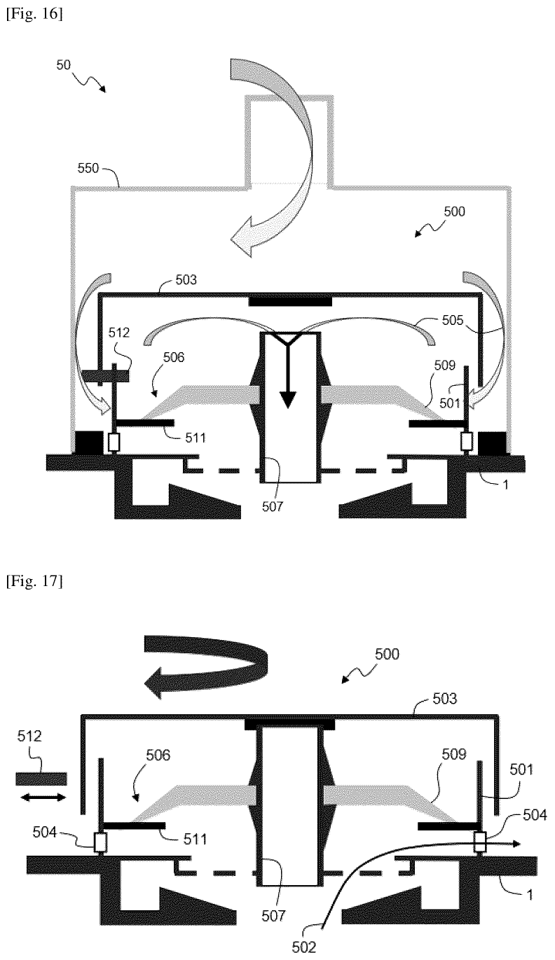

FIGS. 16 and 17 show a pressure equalization device 500 according to another example similar to the pressure equalization device 100 in FIGS. 1 to 8, where similar references represent similar features, incremented by 400. The device 500 is part of a test assembly 50 for testing the airtightness of a battery box 1, similar to the test assembly 10 described above, which comprises a tool 550.

The device 500 according to this example differs from that of FIGS. 1 to 8 in that the membrane 504 is attached to the cage 501 and covers a hole through the cage 501 and the locking means 512 is radially inserted between the locked and unlocked positions. In this example, the central hole 507 passing through the valve element 306 is also hermetically sealed by the lid 503 when the lid 503 is in the operational condition.

The person skilled in the art will understand that the embodiments described above can vary in many ways, provided they are consistent with the scope of the claims.

### LIST OF REFERENCE SYMBOLS

1 battery box
10 test assembly
100 pressure equalization device
150 tool
101 cage
101a locking protuberance
102 a fluid passage
103 lid
103a recess
104 membrane
105 bypass channel
106 valve element
107 center hole
109 canopy
110 second fluid passage
111 valve seat
112 locking means
113 screw formation
114 screw formation
115 locking member
116 spring clip
117 arm
118 barb
119 barb
120 receptacle
121 cage formation
20 test assembly
200 pressure equalization device
250 tool
201 cage
202 a fluid passage
203 lid
204 membrane
205 bypass channel
206 valve element
208 hole
209 canopy
210 second fluid passage
211 valve seat
30 test assembly
300 pressure equalization device
350 tool
301 cage
302 a fluid passage
303 lid
304 membrane
305 bypass channel
306 valve element
307 center hole
308 hole
309 canopy
311 valve seat
312 locking means
40 test assembly
400 pressure equalization device
450 tool
401 cage
402 a fluid passage
403 lid
404 membrane
405 bypass channel
406 valve element
407 center hole
408 hole
409 canopy
411 valve seat
412 locking means
50 test assembly
500 pressure equalization device
550 tool
501 cage
502 a fluid passage
503 lid
504 membrane
505 bypass channel
506 valve element
507 center hole
508 hole
509 canopy
511 valve seat
512 locking means

What is claimed is:

1. A pressure equalization device for a battery box, comprising:
a cage describing a fluid passage;
a lid mounted on the cage; and
a membrane covering the fluid passage to equalize the pressure inside the battery box with the ambient pressure outside the battery box;
in which the lid is movable, when in use, between a test configuration, in which air can escape through a bypass channel, and an operational configuration, in which the bypass channel is closed but air can escape through the membrane.

2. The device according to claim 1, wherein the membrane is gas-permeable and liquid-impermeable to allow air to pass through to equalize the pressure inside the battery box with the ambient pressure outside the battery box.

3. The device according to claim 1, further comprising a valve element configured to deform at a predetermined pressure difference between the inside and the outside of the battery box to prevent overpressure inside the battery box when the lid is in the operational configuration.

4. The device according to claim 3, wherein the valve element comprises a hole through its thickness.

5. The device according to claim 4, wherein the lid is sealed against the hole when the lid is in the operational configuration and spaced apart from the hole when the lid is in the test configuration, so that the bypass channel is defined at least in part between the lid and the valve element.

6. The device according to claim 5, wherein the membrane covers the hole when the lid is in the operational configuration so that the hole provides the fluid passage.

7. The device according to claim 3, wherein the membrane is attached to the valve element and covers a hole through the thickness of the valve element and the bypass channel is defined between the lid and the cage.

8. The device according to claim 5, wherein the membrane is attached to the valve element and covers another hole through the thickness of the valve element.

9. The device according to claim 5, wherein the membrane is attached to the cage and covers a hole through the cage.

10. The device according to claim 3, wherein the valve element comprises a canopy that covers the fluid passage or a second fluid passage defined by the cage.

11. The device according to claim 10, in which the cage comprises a valve seat against which the canopy engages in an airtight manner when the canopy covers the fluid passage or the second fluid passage.

12. The device according to claim 1, further comprising a locking means for keeping the lid in the test configuration and/or in the operational configuration.

13. The device according to claim 1, wherein the lid is rotatable between the test configuration and the operational configuration.

14. The device according to claim 13, wherein one of the lid and of the cage comprises an inclined, helical or screw-shaped formation that cooperates with a formation on the other of the lid and of the cage to cause the lid to translate relative to the cage when it is rotated between the test configuration and the operational configuration.

15. A test assembly for testing the airtightness of a battery box, the assembly comprising a device according to claim 1 and a tool configured to cover the device and to introduce pressurized air into or draw air from the battery box when the device is in the test configuration.
